(19) United States
(12) Patent Application Publication
(10) Pub. No.: US 2008/0202699 A1
(43) Pub. Date: Aug. 28, 2008

(54) End-of-Travel Device For Actuating Systems of Roller Blinds or Sun Shades

(75) Inventor: Andrea Malausa, Ponte di Piave TV (IT)

Correspondence Address: KATTEN MUCHIN ROSENMAN LLP, 575 MADISON AVENUE, NEW YORK, NY, 10022-2585, US

(73) Assignee: NICE SPA, Oderzo (Treviso) (IT)

(21) Appl. No.: 11/911,844

(22) PCT Filed: Apr. 21, 2006
(86) PCT No.: PCT/EP06/61745

§ 371 Date: Oct. 18, 2007

(30) Foreign Application Priority Data
May 6, 2005 (IT) TV2005U000024

(51) Int. Cl. E06B 9/68; E06B 9/88; H02K 7/20

(52) U.S. Cl. 160/133; 160/310; 74/421 A

(57) ABSTRACT

End-of-travel device (10) for roller blind actuating systems, comprising a member (22) displaceable as far as an end-of-travel position (26), coupling means (20) in engagement with the displaceable member (22) and rotationally actuated by a motor, and lever means (40) for converting the displacement of the displaceable member (22) into activation of an end-of- travel switch (60). The lever means (40) comprise a movable member (50) pivotably hinged on a frame and engageable with pressure by the displaceable member (22) when its reaches the end-of-travel position (26). The member (50) can be engaged with an actuating member (58) of the switch (60) where an actuating member of the switch (60) is positioned radially with respect to the axis of displacement of the member (22).

The present invention relates to an end-of-travel device for actuating systems of roller blinds or sun shades, such as shutters, sun awnings, etc.

It is known that in actuating systems for roller blinds (to which reference will be made henceforth for the sake of simplicity, but it being understood that the invention is not limited to this application) for some time automatic end-of-travel devices have been used, namely mechanical or electromechanical devices which cause stoppage of the roller blind when it reaches a predetermined final position.

Many examples of these devices exist in the state of the art. In the patent FR 2,076,529 two gear wheels which advance on associated female screws act on end-of-travel switches (microswitches) displacing flanges which slide coaxially on a smooth portion of the female screws.

In a very similar manner the patent EP 0,371,170 describes actuation of end-of-travel switches by means of gear wheels which advance on associated female screws, where, however, it is the gear wheel itself which acts by means of direct contact on the switch (for this purpose it is chamfered on the contact edge).

These systems, although managing to limit the longitudinal dimensions, do not allow precise adjustment of the end-of-travel stops, resulting in positioning errors of the roller blind. A first cause of error is the sensitivity of the microswitch which is actuated. The commercially available microswitches do not ensure constant operation as regards either the position or the moment of activation, namely they are not always activated at the same moment or in the same position (activation may occur after travelling a third or a half of their total travel path). Moreover, with time their characteristics change. Since the manufacturers of actuating systems use commercially available microswitches, this error cannot be eliminated. On the other hand it is likewise not economically advantageous to produce specific microswitches for this type of application. A second cause of error is the speed with which the microswitch is actuated. This parameter in fact influences the position and the moment of activation. The activation position may be rendered more constant by increasing the speed of actuation of the microswitch.

A commercially known solution is one where end-of-travel microswitches are actuated by gear wheels which advance on associated female screws. In this case, however, the movement of the gear wheels is transferred to the movable part of the microswitch by means of a lever able to multiply the operating speed owing to the different length of its arms. It can be easily understood that the dimensions of the arms of the lever determine directly the performance of the system, but at the same time they are also decisive for the space occupied by the system. However, the dimensions of the actuating system are dependent upon the end-of-travel system, which prevent any shortening thereof. Since the dimensions of the actuating system heavily influence both the practicality of assembly and its cost (production, packaging and storage), it is obvious that this system is not of an optimal nature.

The main object of the present invention is to provide an improved end-of-travel device by means of which the problems and drawbacks briefly mentioned above are substantially solved.

This object is achieved with an end-of-travel device for rotational actuating systems of roller blinds or sun shades, which is mounted on a frame of the roller blind and coupled to a motor for actuating the roller blind, comprising a member displaceable as far as a desired adjustable end-of-travel position, coupling means in engagement with said displaceable member and rotationally actuated by said motor, so that the rotation of said motor and said coupling means causes said displacement of said member, lever means for converting the displacement of said displaceable member into activation of an end-of-travel switch for operating said motor, said lever means comprising a movable member pivotably mounted on the fixed frame and able to be engaged with pressure/thrust by said displaceable member when it reaches said end-of-travel position, the other end of said movable member being engageable with a member for actuating said end-of-travel switch, characterized in that said member for actuating said switch is positioned radially with respect to the axis of displacement of said member, so that when said rotating member reaches said end-of-travel position and engages by means of pressure/thrust with said movable member, said movable member is made to rotate about the pivoting point on the frame, consequently actuating said end-of-travel switch.

In the particular embodiment of the present invention, said arm of the lever means is L-shaped and has a first branch which has an end pivotably mounted on said frame and is engaged with pressure/thrust by said rotating member during its displacement when it reaches the end-of-travel position. The second branch of said arm engages by means of pressure/thrust with the member for actuating said end-of-travel switch.

This innovative idea allows the longitudinal dimensions of the actuating system to be reduced substantially, with all the advantages arising therefrom.

These and further advantages will emerge more clearly from the following description of the device according to the invention, with reference to the accompanying drawings in which:

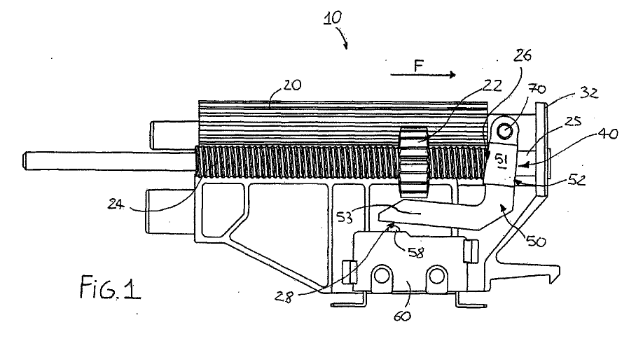

FIG. 1 shows a side view of the device according to the invention;

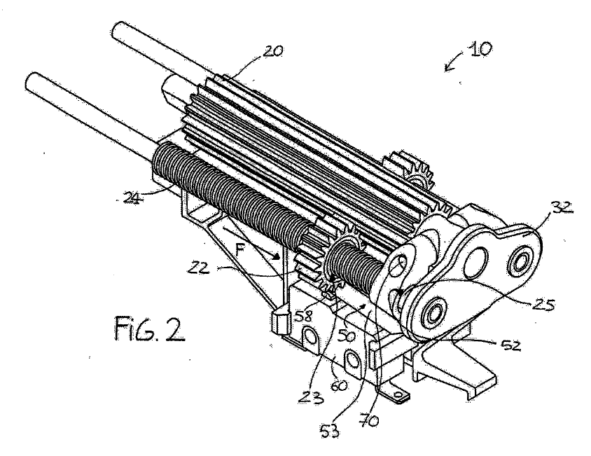

FIG. 2 shows an axonometric view of the device according to FIG. 1 from above;

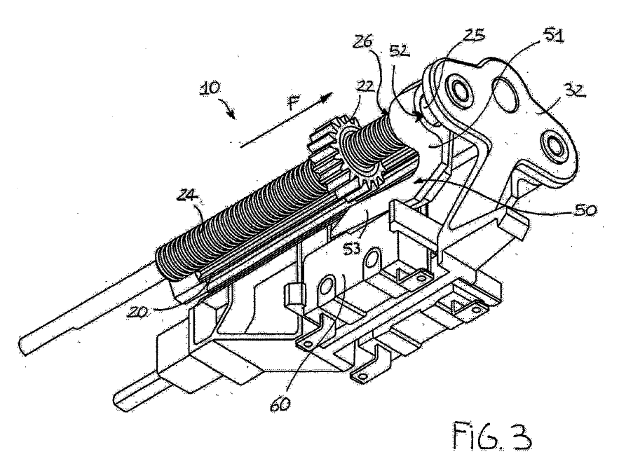

FIG. 3 shows an axonometric view of the device according to FIG. 1 from below;

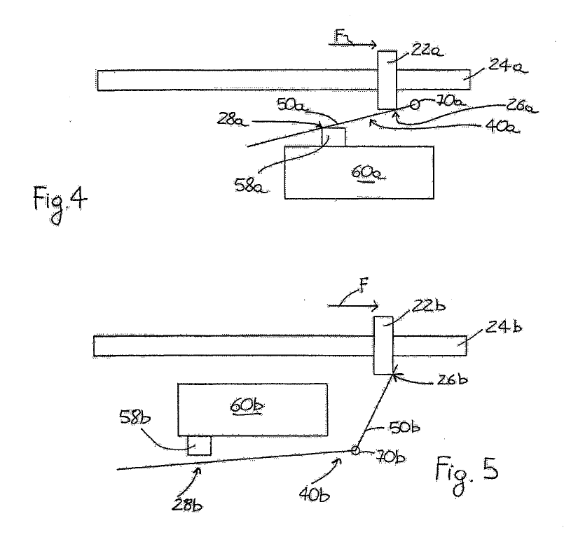

FIG. 4 shows schematically another side view of the device;

FIG. 5 shows schematically another side view of the device.

In the figures of the entire structure of the roller blind only the portion of interest in the region of the end-of-travel system is shown. With reference to the accompanying figures, a device according to the invention is denoted by 10. It normally and preferably consists of two identical end-of-travel devices which are arranged laterally alongside each other and only one of which for the sake of simplicity and brevity will now be described.

The device 10 comprises a rotating splined cylinder 20 mating with a gear wheel 22 which in turn engages, by means of its threaded central hole 23, with the thread of a fixed female screw 24 arranged parallel to the cylinder 20. Both the female screw 24 and the cylinder 20 are supported by a bracket 32 mounted on the frame of the roller blind (the other ends of the female screw 24 and the cylinder 20 are likewise supported by a similar bracket).

By means of a known mechanism, not shown, the motor for rotation of the roller blind (not shown) causes the rotation of said cylinder 20 about its longitudinal axis and consequently the gear wheel 22 advances on the female screw 24 in relation to the rotational movement of the roller blind (direction F in the figures). The advancing movement of the gear wheel 22 along the female screw 24 continues until it reaches an end-of-travel position where it encounters lever means 40 at a pressure/thrust point 26.

The lever means 40 comprise a movable L-shaped arm 50 having the free end of a first branch 51 hinged about a pivot pin 70 on the aforementioned frame. From the figures it can be readily seen that the branch 51 of the lever means 40 has in its thickness a hole 52 inside which a smooth cylindrical portion 25, i.e. without threading, of the female screw 24 passes in a freely slidable manner. In particular the diameter of the hole 52 has dimensions such that between the outer surface of the female screw 24 and the inner wall of the hole 52 there is sufficient play to allow pivoting of the lever means 40 about the fulcrum 70 in a plane passing through the axis of the female screw 24. It is evident that this result may also be achieved by providing the smooth portion 25 with a diameter smaller than that of the main body of the female screw 24.

The second branch 53 of the arm 50, which in the embodiment shown is situated at an angle preferably of ninety degrees with respect to the branch 51, engages, in the position indicated by the reference number 28, with the actuating member or pushbutton 58 of an end-of-travel switch 60, which is advantageously a microswitch. With this configuration it is possible to position the end-of-travel switch and in particular its actuating pushbutton 58 in a position radially spaced from the axis of the female screw 24, but within the limits of the longitudinal dimensions of the said female screw, therefore allowing shortening of the longitudinal length of the roller blind to the length of the female screw without any further extension. As can be seen from the Figures, the operating principle of the invention is as follows: when the gear wheel 22 reaches the end-of-travel position at the pressure/thrust point, it exerts at this point 26 a force on the first branch 51, so that the branch 50 rotates about the fulcrum 70. Owing to this rotation, the second branch 53 of the arm 50 in turn exerts on the contact point 28 an activating force on the pushbutton 58 of the end-of-travel switch 60. When the switch 60 is activated, actuating means (not shown) causes stoppage or reversal (and/or another function) of the roller blind. Then the roller blind may move only in the reverse direction, causing reverse rotation of the cylinder 20 and forward movement of the wheel 22 in a direction opposite to the previous direction F.

In order to provide two end-of-travel positions it is possible to use two separate devices (one per position), as shown in the figures, or arrange a second movable pivoting member on the other end of the female screw 24 so as to activate a second end-of-travel switch.

With reference to FIGS. 4 and 5, a schematic description is now given of two mechanical equivalents of the invention, the parts of which constructionally identical to the already described parts will be distinguished by the suffixes “a” and “b”, respectively, parts not named remaining the same even if not shown.

In FIG. 4 a gear wheel 22a advances rotating on the thread of a female screw 24a in relation to the movement of the roller blind (direction F in the figure). As it advances, the gear wheel 22a reaches an end-of-travel position at a pressure/thrust point 26a where it encounters lever means 40a comprising a straight movable arm 50a with its fulcrum on the pivot pin 7a . The movable arm 50a, when it is engaged by the gear wheel 22a, rotates about its fulcrum 70a and exerts, at a point 28a, an activating force on a pushbutton 58a of an end-of-travel switch 60a. Here the movable member 50a is pivotably hinged in a position adjacent to the pressure point 26a. With respect to the female screw 24, the pin 70a and the pressure point 26a are radially on the same side.

In FIG. 5 a gear wheel 22b advances rotating on the thread of a female screw 24b in relation to the movement of the roller blind (direction F in the figure). As it advances, the gear wheel 22b reaches an end-of-travel position at a pressure/thrust point 26b where it encounters lever means 40b comprising a movable V-shaped member 50b with its fulcrum on a pivot pin 70b. The movable member 50b exerts, at a point 28b, an activating force on a pushbutton 58b of an end-of-travel switch 60b. In this case the movable member 50b is pivotably hinged in a position about halfway between the pressure/thrust point 26b and the point 28b of application of the activating force. The switch 60b, unlike the previous examples, does not have its pushbutton 58a directed towards the female screw 24b (i.e. is directed radially away from the female screw 24b).

When the gear wheel 22b reaches the end-of-travel position at the pressure/thrust point 26b, it exerts a force on the movable member 50b which, rotating about the fulcrum 70b, exerts at the point 28b an activating force on the pushbutton 58b of the end-of-travel switch 60b.

For the invention, as lever means it is possible to use any type of passive kinematic mechanism, for example hinged transmission or gear systems particular types of levers). Moreover, for the lever means, it is possible to make use of the activating bar already present in some commercially available microswitches.

It is mentioned that, instead of the female screw and the thread type system for coupling with the rotating member, it is possible to use equivalent mechanisms provided that they allow displacement of a movable member, controlled by rotation of the roller blind motor.

1. End-of-travel device (10) for rotational actuating systems of roller blinds or sun shades, mounted on a frame of the actuating system and coupled to an actuating motor of the roller blind, comprising a member (22; 22a; 22b) displaceable as far as a desired adjustable end-of-travel position (26), coupling means (20) in engagement with said displaceable member (22; 22a; 22b) and rotationally actuated by said motor, so that the rotation of said motor and said coupling means causes said displacement of said member (22; 22a; 22b), lever means (40) for converting the displacement of said displaceable member (22; 22a; 22b) into activation of an end-of-travel switch (60) for operating said motor, said lever means (40) comprising a movable member (50; 50a; 50b) pivotably mounted on the frame and engageable with pressure by part of said displaceable member (22; 22a; 22b) when its reaches said end-of-travel position (26), the other end of said movable member (50; 50a; 50b) being engageable with an actuating member (58; 58a; 58b) of said end-of-travel switch (60; 60a; 60b), characterized in that said actuating member (58; 58a; 58b) of said switch (60; 60a; 60b) is positioned radially with respect to the axis of displacement of said member (22; 22a; 22b), so that when said rotating member (22; 22a; 22b) reaches said end-of-travel position and engages by means of pressure with said movable member (50; 50a; 50b), said movable member (50; 50a; 50b) is made to rotate about the pivoting point on the frame, consequently actuating said end-of-travel switch.

2. Device (10) according to claim 1, in which said lever means (40) comprise a single movable member (50).

3. Device (10) according to claim 1, in which said lever means (40) forms a lever of the third order.

4. Device (10) according to claim 1, in which said displaceable member is a gear wheel (22) which in turn engages, by means of its threaded central hole (23) with the thread of a fixed female screw (24).

5. Device (10) according to claim 4, in which, with respect to the female screw (24), the fulcrum of said movable member (50) is positioned in a position opposite to the actuating point of said end-of-travel switch (60).

6. Device (10) according to claim 5, in which said movable member (50) is L shaped and is pivotably hinged about a pin (70) on said frame.

7. Device (10) according to claim 6, in which said movable member (50) comprises along its extension a ring (52) inside which a smooth cylindrical portion (25) of the female screw (24) can rotate, the diameter of the ring (52) being such as to leave play with respect to the body of the smooth portion (25) and allow pivoting of the movable member (50) about the pin (70).

8. Device (10) according to claim 4, in which the movable member (50a) is pivotably hinged with a pin (70a) in a position adjacent to the pressing point (26a) of the displaceable member and, with respect to the female screw (24a), the pin (70a) and the point (26a) are radially on the same side.

9. Device (10) according to claim 4, in which the movable member (50b) is hinged with a pin (70b) in a position about halfway between the pressing point (26b) of the displaceable member and the actuating member of said end-of-travel switch (60a), said actuating member (28b) being directed radially away from the female screw (24b).

10. Device (10) according to claim 1, in which said coupling means (20) in engagement with said displaceable member (22; 22a; 22b) comprise a rotating splined cylinder (20).
